(19) United States
(12) Patent Application Publication
(10) Pub. No.: US 2016/0057735 A1
(43) Pub. Date: Feb. 25, 2016

(54) METHODS OF SIGNALING MCS

(71) Applicant: ALCATEL LUCENT, Boulogne Billancourt (FR)

(72) Inventors: Jin Liu, Shanghai (CN); Yubo Yang, Shanghai (CN); Fang-Chen Cheng, Randolph, NJ (US); Kun Zhao, Shanghai (CN); Xudong Zhu, Shanghai (CN)

(73) Assignee: Alcatel Lucent, Boulogne Billancourt (FR)

(21) Appl. No.: 14/778,737

(22) PCT Filed: Mar. 4, 2014
(86) PCT No.: PCT/IB2014/000502

§ 371 Date: Sep. 21, 2015

(30) Foreign Application Priority Data
Mar. 21, 2013 (CN) 201310093556.5

(51) Int. Cl. H04W 72/04

(52) U.S. Cl. CPC H04W 72/04

(57) ABSTRACT

The invention proposes methods of signaling MCS. Current standard does not support more MCS levels. A method in an e NB for signaling MCS, comprising steps of: i. generating (S12) a message with a first index, wherein the first index is used to select a MCS level from a first dataset, wherein the first dataset comprising any one of: one or more modulation types higher than 64QAM; and one or more combinations of given modulation types and code rates different from corresponding given code rates; and ii. Transmitting (S14) said message with said first index to a UE. A method in an UE for receiving MCS, comprising steps of: a. receiving from an e NB a message with a first index, wherein the first index is used to select a MCS level from a first dataset; and b. determining the MCS according to said first index and said first dataset. The present invention enable more MCS levels to be signaled to UE, which paves the way for these MCS levels to be implemented in LTE-A system.

### TECHNICAL FIELD

This disclosure relates to wireless communications, and particularly to signaling in wireless communications.

### BACKGROUND OF THE INVENTION

In recent years, the concept of Small Cells has been introduced to describe the family of all the short-range radio cells such as femto/pico/microcells, using cognition and awareness to effectively break off from the cellular structure constraints, increasing outdoor and indoor capacities. Although the small cell networks have the potential to significantly increase the capacity of cellular networks while reducing their energy consumption, they pose many new challenges to the optimal system design.

In 3GPP TSG RAN Workshop, a new Study Item proposal of LTE small cell enhancements was agreed for LTE-Advanced Release-12 (RP-122032, Huawei, HiSilicon, CATR, “New Study Item Proposal for Small Cell Enhancements for E-UTRA and E-UTRAN—Physical-layer Aspects”, Barcelona, Spain, 3GPP TSG-RAN Meeting #58, December 2012). One of the objectives of this study is to identify potential enhancements to improve the spectrum efficiency, i.e., achievable user throughput in typical coverage situations. The downlink (DL) higher order modulation scheme (e.g., 256QAM) was proposed as an attractive solution to achieve high peak data rates in small cells.

The system which employs higher order modulation scheme are potentially more sensitive to multipath propagation effects, inter-cell interference and thermal noise as well as the degradations imposed by practical manufacturing constraints. This sensitivity of higher order modulation imposes more stringent requirements on the linearity of the transceivers and the power amplifiers. Fortunately, these issues have been studied comprehensively and could be addressed with some more complex RF chains in these years. Therefore it is possible that 256QAM is adopted by LTE-Advanced small cell systems as an optional feature.

### SUMMARY OF THE INVENTION

To support the transmission and reception of downlink data, the downlink L1/L2 control signaling is used to dynamically convey the downlink scheduling assignments including information required for the UE to be able to properly receive, demodulation, and decode the DL-SCH on a component carrier. Among them, the modulation and coding scheme (MCS) which is to be used by the eNB to transmit DL data should be signaled to the UE, thereby enabling the UE to use a corresponding demodulation and decoding scheme to restore the data.

In the downlink L1/L2 control signaling consisting of DCI formats 1/1A/1B/1C/1D and 2/2A/2B/2C, the modulation and coding scheme (MCS) field of each transport block occupies 5 information bits. The UE first reads the 5-bit MCS field (I_{MCS}) in the DCI and then determines the modulation type and transport block size(s) in the physical downlink shared channel (PDSCH) according to Table 1. Wherein, the transport block size(s) is corresponding to code rate.

TABLE 1

| MCS Index | Modulation type | TBS Index |
|---|---|---|
| I_{MCS} | Qₘ | I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 2 | Reserved |
| 30 | 4 | |
| 31 | 6 | |

The modulation types Qₘ=2, 4, 6 correspond to QPSK, 16QAM and 64QAM, respectively. It can be observed from the table that each modulation type is composed of 7˜12 MCS levels (different TBS Index (transport block sizes), which is corresponding to the code rate). And it can be seen that this 5-bit MCS field has be used up by QPSK, 16QAM and 64QAM.

Consequently, the current MCS field consisting of 5 information bits in DCI formats cannot indicate the additional higher order modulation up to 256QAM. How to signal an MCS of 256QAM to the UE is a technical problem to be solved by embodiments of the invention. Additionally, if there is need to support more code rates for the existing modulation types, this need can neither be satisfied due to that there is not enough available information bits left in the present DCI formats.

To better address this concern, one basic inventive concept of the embodiments of the invention is using an index from a first dataset to indicate the higher order modulation or the more code rates.

In a first aspect of the invention, it is proposed a method in an eNB for signaling MCS, comprising steps of: i. generating a message with a first index, wherein the first index is used to select a MCS level from a first dataset, wherein the first dataset comprising any one of: one or more modulation types higher than 64QAM; and one or more combinations of given modulation types and code rates different from corresponding given code rates; and ii. transmitting said message with said first index to a UE.

In this aspect, in one hand, the first dataset comprises one or more modulation types higher than 64QAM. Therefore, the higher modulation types can be signaled. With the new solutions of MCS mapping, the higher-order modulation could be support to achieve higher spectral efficiency for small cell enhancements, paving the way of implementing higher order modulation such as 256QAM in LTE system.

Additionally or alternatively, on the other hand, the first dataset comprises one or more combinations of given modulation types and code rates different from corresponding given code rates. The “given modulation type” stands for the existing modulation types in LTE, namely QPSK, 16QAM and 64QAM, and the “given code rates” stands for the existing code rates for each of the existing modulation types respectively. Therefore, the higher code rates for existing modulation types can be supported.

In a preferred embodiment, wherein said first dataset comprises a set of MCS levels including QPSK, 16QAM, 64QAM and higher modulation types comprising 256QAM, and said MCS levels in said first dataset are a set of combinations of these modulation types with different code rates, wherein the higher modulation type are combined with lower and/or higher code rates.

In this embodiment, all modulation types can be directly indicated by one first index, and this is quite convenient for both eNB and UE.

In another preferred embodiment, the method further comprises steps of:

deciding whether or not that the UE uses first dataset, when deciding that the UE uses first dataset, performing said step i; otherwise, performing steps of:

i′. generating a message with a second index, wherein said second index is used to select a MCS level from a second dataset comprising one or more modulation types no higher than 64QAM.

In this embodiment, the first dataset and the second dataset are proposed respectively for high order modulation and low order modulation. A selectivity is realized. Besides, since each of the first index and the second index indicate a part of all modulation types, they are not necessarily excessively long, thus the transmitting and detection of these indexes would be easy.

In a further embodiment, the method comprises a step of:

transmitting via RRC signaling to the UE an indication of whether the UE uses the first dataset or the second dataset;

In this embodiment, whether the UE uses high order dataset or low order dataset is determined and signaled by the eNB. And the eNB can control this according to the UE status, such as UE position or CIS, and signaling this to the UE via RRC in a slow time variation manner. This indication could reflect a general MCS condition for the UE under its status. After that, the first or second index can be transmitted in the PDCCH in a fast time variation manner, and this index could represent a specific MCS level for the UE and has a high real time characteristic.

In another further embodiment, said first dataset consists of:

a set of MCS levels without QPSK, 16QAM or 64QAM; or

a set of MCSs levels including QPSK, 16QAM, 64QAM and higher orders comprising 256QAM, these MCSs levels being a subset of combinations of these modulations with code rates.

In this embodiment, in one case, the first dataset does not include one low modulation type, such as QPSK, 16QAM or 64QAM, thus with respect to the current standard, information bits for this order can be saved for the higher orders such as 256QAM.

In another case, both high and low modulation types are included thus a wide modulation type range can be realized; and some code rates for these modulation types are not included, thus with respect to the current standard, information bits for these code rates can be saved for higher orders such as 256QAM.

In these two cases, the length of the first index need not be too long due to the limit of the size of the first dataset, thereby sending and inspecting the index easily.

In still another further embodiment, said second dataset consists of:

a set of MCS levels with one or more modulation types no higher than 64QAM; or

a set of MCSs levels including QPSK, 16QAM, 64QAM and higher orders comprising 256QAM, these MCSs levels being a subset of combinations of these modulations with code rates.

In this embodiment, two specific types for the second dataset for low order modulation are proposed. The first type can reuse the MCS bits in the current standard. And the second type can provide a wide modulation type range. In these two types, the length of the second index need not be too long due to the limit of the size of the second dataset, thereby sending and inspecting the index easily.

In one embodiment, said deciding step decides whether the UE uses the first dataset or the second dataset according to a category of the UE, and said category relates to at least any one UE feature of:

a communication capability of the UE;

an implementation supports of the UE;

a service level of the UE.

In this embodiment, the eNB determines whether the UE uses first dataset or second dataset according to category of the UE, and does not need to inform the UE. The UE also determines whether the UE uses first dataset or second dataset according to category of the UE in consistence with the eNB. Therefore the selectivity is realized without additional signaling between the eNB and UE, and signaling overhead is avoided. And, the flexibility and pertinence of scheduling is improved by selecting the first dataset or the second dataset according to UE features, which enables modulation types to be selected reasonably according to UE features. Preferably, the first dataset corresponds to high order modulation and the second dataset corresponds to low order modulation. The high end UE can select the high order modulation, while low end UE can select the low order modulation.

In one embodiment, the lengths of the first index and the second index are 5 bits, and the message is DCI format.

In this embodiment, the MCS field in the DCI format of the current standard can be used for carrying the first index or the second index. Thus the current MCS field and DCI format do not need any modification, and therefore good backward compatibility is realized.

Correspondingly, in a second aspect of the invention, it is proposed a method in an UE for receiving MCS. The method comprises steps of:

a. receiving from an eNB a message with a first index, wherein the first index is used to select a MCS level from a first dataset, wherein the first dataset comprising any one of:

one or more modulation types higher than 64QAM;

one or more combinations of given modulation types and code rates different from corresponding given code rates;

b. determining the MCS according to said first index and said first dataset.

In another basic inventive concept of embodiments of the invention, two indexes are used together to indicate an MCS level which is a combination of a modulation type and a code rate.

In a third aspect of the invention, a method of signaling MCS, comprising steps of:

generating a message with a first index;

transmitting the message with the first index to a UE;

generating another message with a second index;

transmitting said another message with said second index to the UE;

wherein said second index is used for indicating an adjustment to the first index, and said first index and said second index are for determining a MCS level together.

In this aspect, a two-stage signaling method is proposed to signal the MCS to the UE. Considering the limited number of UEs and the low mobility property of UEs in small cells, for a certain UE, the link adaptation may not span too many MCS levels within a limited time window. Therefore an adjustment to the MCS is enough for an optimized MSC, instead of signaling a new MCS. Second, two indexes can cover a wide range of modulation types. Besides, since the second index can be used for adjusting the first index, both the first and second indexes are not necessarily long.

In a preferred embodiment, said transmitting the another message with the second index and said transmitting the message with the first index are respectively in contiguous subframes or in subframes within a certain interval.

In this embodiment, the UE can determine the second index is an adjustment instead of an new MCS in case that the second index is transmitted right after or shortly after the first index. There is no additional overhead to indicate the second index is an adjustment.

In a preferred embodiment, the MCS level determined by the first index and the second index is from a set of MCS levels with the modulation types including one or more modulation types higher than 64QAM.

In this embodiment, the two indexes can cover a wide range of modulation types including 256QAM, thereby paving the way of realizing 256QAM for LTE systems.

In a preferred embodiment, the lengths of the first index and the second index are 5 bits, and the message is DCI format.

In this embodiment, the MCS field in the DCI format of the current standard can be used for carrying the first index and the second index. Thus the current MCS field and DCI format do not need any modification, and therefore good backward compatibility is realized.

In a fourth aspect of the invention, correspondingly, it is proposed a method of receiving MCS, comprising steps of:

receiving a message with a first index;

receiving another message with a second index;

wherein said second index is used for indicating an adjustment to the first index, and said first index and said second index are for determining a MCS level together;

determining the MCS according to the first index and the second index.

These and other aspects of the invention will be apparent from and elucidated with reference to the embodiment(s) described hereinafter.

### BRIEF DESCRIPTION OF THE DRAWINGS

Features, aspects and advantages of the present invention will become obvious by reading the following description of non-limiting embodiments with the aid of appended drawings.

FIG. 1 shows a flow chart of an embodiment of the invention for signaling MCS from eNB to UE.

Throughout the above drawings, like reference numerals will be understood to refer to like, similar or corresponding features or functions.

### DETAILED DESCRIPTION OF EMBODIMENTS

The invention proposes a method in an eNB for signaling MCS, comprising steps of:

i. generating a message with a first index, wherein the first index is used to select a MCS level from a first dataset, wherein the first dataset comprising any one of:

one or more modulation types higher than 64QAM; and

one or more combinations of given modulation types and code rates different from corresponding given code rates;

ii. transmitting said message with said first index to a UE.

Correspondingly, the invention also proposes a method in an UE for receiving MCS, comprising steps of:

a. receiving from an eNB a message with a first index, wherein the first index is used to select a MCS level from a first dataset, wherein the first dataset comprising any one of:

one or more modulation types higher than 64QAM;

one or more combinations of given modulation types and code rates different from corresponding given code rates;

b. determining the MCS according to said first index and said first dataset.

The following description would elucidate different embodiments of the invention.

### Embodiment 1

In this embodiment, the first dataset comprises a set of MCS levels including QPSK, 16QAM, 64QAM and higher modulation types comprising 256QAM, and the MCS levels in the first dataset are a set of combinations of these modulation types with different code rates, wherein the higher modulation type are combined with lower and/or higher code rates.

An example for the first dataset can be shown in the following table 2.

TABLE 2

| MCS Index | Modulation type | TBS Index |
|---|---|---|
| I_{MCS} | Qₘ | I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 8 | 26 |
| 30 | 8 | 27 |
| 31 | 8 | 28 |
| 32 | 8 | 29 |
| 33 | 8 | 30 |
| 34 | 8 | 31 |
| 35 | 8 | 32 |
| 36 | 8 | 33 |
| 37 | 8 | 34 |
| 38 | 8 | 35 |
| 39 | 2 | reserved |
| 40 | 4 | |
| 41 | 6 | |

Wherein modulation types 2, 4, 6, and 8 respectively stands for QPSK, 16QAM, 64QAM and 256QAM.

In table 2, 256QAM has ten MCS levels, namely ten combinations of 256QAM and different code rates. By comparing table 2 with the current table 1, it can be seen that the additional ten MCS levels for the higher order modulation (e.g., 256QAM) needs additional 4 information bits. Thus, the current 5-bit MCS fields in DCI formats could be extended to 9 information bits, which introducing new DCI format and MCS field format. It should be understood that other numbers of MCS levels for 256QAM are also applicable. 256QAM could comprises 7-12 MCS levels or even more.

After receiving first index sent by eNB, UE searches modulation type index and TBS index corresponding to the first index in the first dataset to determine MCS level used by eNB. The first dataset can be prestored in UE or be sent by eNB in advance when the UE accesses to the network.

It should be noted that other modulation types higher than 64QAM, such as 128QAM can also be incorporated in the first dataset. Even in the future, the higher modulation type higher than 256QAM can also be incorporated in the first dataset.

### Embodiment 2

In this embodiment, two datasets can be used to indicate different corresponding relationship of index and MCS level. The eNB and the UE determine which one to use. Wherein, preferably, two dataset can be used respectively for low order modulation and high order modulation.

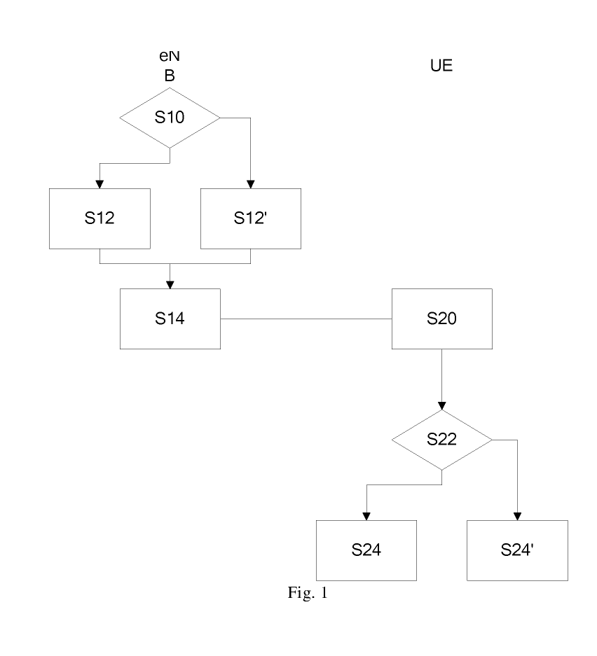

As shown in FIG. 1, in step S10, the eNB decides whether or not that the UE uses first dataset. Specifically, in one embodiment, the first dataset corresponds to high order modulation. Then the eNB can obtain the downlink channel condition from the eNB to the UE, and decides that the UE uses a high order modulation such as 256QAM in case the channel condition is excellent. In another embodiment, the eNB decides whether or not that the UE uses first dataset according to the category of the UE, for example whether the UE is a high-end UE or belongs to a VIP subscriber.

In case the eNB decides to use first dataset, the method proceeds to step S12. In step S12, the eNB generates a message with a first index, wherein the first index is used to select a MCS level from a first dataset, the first dataset consists of a set of MCS levels without QPSK, 16QAM or 64QAM. One example for the first set is shown in table 3:

TABLE 3

| | | TBS |
|---|---|---|
| MCS Index | Modulation type | Index |
| I_{MCS} | Qₘ | I_{TBS} |
| 0 | 4 | 9 |
| 1 | 4 | 10 |
| 2 | 4 | 11 |
| 3 | 4 | 12 |
| 4 | 4 | 13 |
| 5 | 4 | 14 |
| 6 | 4 | 15 |
| 7 | 6 | 15 |
| 8 | 6 | 16 |
| 9 | 6 | 17 |
| 10 | 6 | 18 |
| 11 | 6 | 19 |
| 12 | 6 | 20 |
| 13 | 6 | 21 |
| 14 | 6 | 22 |
| 15 | 6 | 23 |
| 16 | 6 | 24 |
| 17 | 6 | 25 |
| 18 | 6 | 26 |
| 19 | 8 | 26 |
| 20 | 8 | 27 |
| 21 | 8 | 28 |
| 22 | 8 | 29 |
| 23 | 8 | 30 |
| 24 | 8 | 31 |
| 25 | 8 | 32 |
| 26 | 8 | 33 |
| 27 | 8 | 34 |
| 28 | 8 | 35 |
| 29 | 2 | reserved |
| 30 | 4 | |
| 31 | 6 | |

Wherein modulation types 4, 6, and 8 respectively stands for 16QAM, 64QAM and 256QAM. Preferably, the length of the first index (MCS Index) is 5-bit, and it is the same as the MCS field in the current standard. In this embodiment, QPSK is removed, while in other possible embodiments, either 16QAM or 64QAM can be removed instead of QPSK.

In an alternative embodiment, all modulation types namely QPSK, 16QAM, 64QAM and 256QAM are included in the first dataset, but with respect to current standard, only a part of their corresponding code rates are adopted and the total number of MCS level are maintained as 32. Therefore a first index with a 5-bit length is enough to indicate MCS in first dataset, and the current 5-bit MCS field is also enough to accommodate the first index. Hence, the current MCS field and DCI format can be reused. One example for the first set is shown in table 4.

TABLE 4

| | Modulation | |
|---|---|---|
| MCS Index | type | TBS Index |
| I_{MCS} | Qₘ | I_{TBS} |
| 0 | 2 | 0 |
| 1 | 2 | 2 |
| 2 | 2 | 4 |
| 3 | 2 | 6 |
| 4 | 2 | 8 |
| 5 | 2 | 9 |
| 6 | 4 | 9 |
| 7 | 4 | 11 |
| 8 | 4 | 13 |
| 9 | 4 | 15 |
| 10 | 6 | 15 |
| 11 | 6 | 17 |
| 12 | 6 | 19 |
| 13 | 6 | 21 |
| 14 | 6 | 22 |
| 15 | 6 | 23 |
| 16 | 6 | 24 |
| 17 | 6 | 25 |
| 18 | 6 | 26 |
| 19 | 8 | 26 |
| 20 | 8 | 27 |
| 21 | 8 | 28 |
| 22 | 8 | 29 |
| 23 | 8 | 30 |
| 24 | 8 | 31 |
| 25 | 8 | 32 |
| 26 | 8 | 33 |
| 27 | 8 | 34 |
| 28 | 8 | 35 |
| 29 | 2 | reserved |
| 30 | 4 | |
| 31 | 6 | |

It can be seen from the table-4 that, comparing with table-1, QPSK, 16QAM and 64QAM are only combined with partial code rate to be MCS level, and add 256QAM and each corresponding code rate.

In case the eNB decides to use low modulation types, the method proceeds to step S12′. In step S12′, the eNB generates a message with a second index, wherein said second index is used to select a MCS level from a second dataset comprising one or more modulation types no higher than 64QAM.

Specifically, in one embodiment, the second dataset consists of a set of MCS levels with one or more modulation types no higher than 64QAM. One example for this second dataset is the dataset in the current standard as shown in table 1.

In another embodiment, all modulation types namely QPSK, 16QAM, 64QAM and 256QAM are included in the second dataset, but relative to current standard, their corresponding code rates are removed partially and the total number of MCS level are maintained as 32. Therefore a 5-bit first index is also enough and the current MCS field and DCI format can be reused. It can be understood that both first dataset and second dataset could include 256QAM modulation which could be different in MCS level. The high order modulation in first dataset corresponds to the more quantity of MCS level so as to indicate a variety of code rate combined with 256QAM better. In contrast, the high order modulation in second dataset can include the less quantity of MCS level and include the more MCS level for low order modulation.

After step S12 or S12′, the eNB transmits the generated message with the first index or second index to the UE. Meanwhile, in step S20, the UE receives this message.

In step S22, the UE decides whether or not that the UE uses first dataset.

In one example, after step S10, the eNB further transmits via RRC signaling to the UE an indication of whether the UE uses the first dataset or the second dataset. And the UE receives this indication. RRC signaling is a UE-specific signaling, the eNB can control each UE respectively whether the UE should uses the first dataset or the second dataset. Alternatively, a broadcasting signaling such as that in the BCCH can be used to instruct a plurality of UE to use the first dataset or the second dataset. In step S22, the UE decides whether to use first dataset or second dataset according to the received indication.

In another example, in step S22, the UE decides whether the UE uses the first dataset or the second dataset according to a category of the UE, and the category of the UE relates to at least any one UE feature of:

a communication capability of the UE;

an implementation supports of the UE;

a service level of the UE.

For example, if the UE is a high-end UE such as a high-end smart phone, the communication capability or implementation supports is high, thus the UE may decide to use high modulation type and use first dataset correspondingly. Or, if the subscriber information from the sim card denotes this subscriber is a VIP subscriber with a high service level, the UE may decide to use low modulation type and use first dataset correspondingly. It should be noted that the criteria used by the UE and by the eNB, in determining to use first dataset or second dataset according to the category of the UE, should be in consistence.

After that, if it is decided that the UE is to use high order modulation, namely to use the first dataset, in step S24, the UE determines the MCS according to the first index in the received message and the first dataset prestored in the UE. Otherwise, the method proceeds to step S24′, and the UE determines the MCS according to the second index in the received message and the second dataset prestored in the UE. The first and second datasets can be prestored in the sim card, in the equipment itself or be sent by eNB in advance when the UE accesses to the network.

In the second aspect, in this embodiment, considering the limited number of UEs and the low mobility property of UEs in small cells, the link adaptation may not span too many MCS levels within a limited time window. Under this assumption, we could design two stages of MCS indication.

The present invention provides a method of signaling MCS, comprising steps of:

generating a message with a first index;

transmitting the message with the first index to a UE;

generating another message with a second index;

transmitting said another message with said second index to the UE;

wherein said second index is used for indicating an adjustment to the first index, and said first index and said second index are for determining a MCS level together.

The present invention also provides a method of receiving MCS, comprising steps of:

receiving a message with a first index;

receiving another message with a second index;

wherein said second index is used for indicating an adjustment to the first index, and said first index and said second index are for determining a MCS level together;

determining the MCS according to the first index and the second index.

Above aspects of the invention will be described hereinafter in detail.

At the 1^{st} stage, the 5-bit MCS field indicates the existing MCS level (i.e., I_{MCS1}). Preferably, the data to the desired UE are transmitted according to the current DCI formats by eNB. The UE may refer to a current dataset as shown in table 1 to determine the MCS level corresponding to I_{MCS1}.

Preferably, base station eNB can send a second index to adjust the I_{MCS1} in a contiguous subframe or in a non-contiguous subframe with a limited separation. This is the MCS indication in 2^{nd} stage. A 5-bit second index in MCS field with current DCI format is sent to the same UE by eNB. It can be understood that the method of sending second index include but not limited to above method, for example, when sending the second index, eNB can use a mark bit to indicate the second index is an adjustment to the first index, but not a new index. At the 2^{nd} stage, the second index is used for indicating an adjustment to the first index. For example, the second index indicates a offset ΔI_{MCS}, the MCS indicated together by first index and second index is the MCS (level) corresponding to I_{MCS2}=I_{MCS1}+ΔI_{MCS}.

Then, the UE may refer to an overall dataset consist of all modulation types to determine the MCS level for I_{MCS2}. This dataset includes one or more modulation types higher than 64QAM, such as 256QAM. One example for this dataset can be shown by table 2. Since this dataset also comprises low order MCS levels, in the 1^{st} stage, this dataset can also be used, thus the current table 1 can be spared.

It should be noted that the above first index and second index are not necessarily limited to be 5-bit long. They could be shorter than 5-bit, and the redundant bit of the 5 bit MCS field for accommodating first index and second index can be filled randomly.

In another example, first dataset includes one or more combinations of given modulation types and code rates higher than corresponding given code rates. Wherein the “given modulation type” stands for the existing modulation types in LTE, namely QPSK, 16QAM and 64QAM, and the “given code rates” stands for the existing code rates for each of the existing modulation types respectively. Relative to MCS level in table-1, the first dataset provided by said embodiment is shown in table-5.

TABLE 5

| | Modulation | |
|---|---|---|
| MCS Index | type | TBS Index |
| I_{MCS} | Qₘ | I_{TBS} |
| 0 | 2 | 0 |
| 1 | 2 | 2 |
| 2 | 2 | 4 |
| 3 | 2 | 6 |
| 4 | 2 | 8 |
| 5 | 2 | 9 |
| 6 | 4 | 9 |
| 7 | 4 | 10 |
| 8 | 4 | 12 |
| 9 | 4 | 14 |
| 10 | 4 | 16 |
| 11 | 4 | 18 |
| 12 | 4 | 20 |
| 13 | 6 | 20 |
| 14 | 6 | 21 |
| 15 | 6 | 22 |
| 16 | 6 | 23 |
| 17 | 6 | 24 |
| 18 | 6 | 25 |
| 19 | 6 | 26 |
| 20 | 6 | 27 |
| 21 | 6 | 28 |
| 22 | 6 | 29 |
| 23 | 6 | 30 |
| 24 | 6 | 31 |
| 25 | 8 | 31 |
| 26 | 8 | 32 |
| 27 | 8 | 33 |
| 28 | 8 | 34 |
| 29 | 2 | reserved |
| 30 | 4 | |
| 31 | 6 | |

Wherein the modulation types Qₘ=2, 4, 6 and 8 correspond to QPSK, 16QAM, 64QAM and 256QAM respectively. Comparing with table-1, it can be observed that both 16QAM and 64QAM are combined with code rate higher than given code rate in current standard to get MCS level. And 256QAM modulation type and corresponding high code rate are introduced further for combination. It can be understood that these modulation types can also be combined with code rate lower than given code rate in current standard to get MCS level.

Those ordinary skilled in the art could understand and realize modifications to the disclosed embodiments, through studying the description, drawings and appended claims.

The word “comprising” does not exclude the presence of elements or steps not listed in a claim or in the description. The word “a” or “an” preceding an element does not exclude the presence of a plurality of such elements. In the practice of present invention, several technical features in the claim can be embodied by one component. In the claims, any reference signs placed between parentheses shall not be construed as limiting the claim.

1. A method in an eNB for signaling MCS, comprising:
generating a message with a first index, wherein the first index is used to select a MCS level from a first dataset, wherein the first dataset comprising any one of:
one or more modulation types higher than 64QAM; and
one or more combinations of given modulation types and code rates different from corresponding given code rates;
transmitting said message with said first index to a UE.

2. The method of claim 1, wherein said first dataset comprises a set of MCS levels including QPSK, 16QAM, 64QAM and higher order modulation types comprising 256QAM,
and said MCS levels in said first dataset are a set of combinations of these modulation types with different code rates, wherein the higher order modulation types are combined with lower and/or higher code rates.

3. The method of claim 1, further comprising:
deciding whether or not that the UE uses the first dataset, when deciding that the UE uses said first dataset, performing said generating; otherwise, performing:
generating a message with a second index, wherein said second index is used to select a MCS level from a second dataset comprising one or more modulation types no higher than 64QAM.

4. The method of claim 3, further comprising:
transmitting via RRC signaling to the UE an indication of whether the UE uses the first dataset or the second dataset;
wherein said first dataset consists of:
a set of MCS levels without QPSK, 16QAM or 64QAM; or
a set of MCSs levels including QPSK, 16QAM, 64QAM and higher order modulation types comprising 256QAM, these MCSs levels being a subset of combinations of these modulation types with code rates.

5. The method of claim 3, further comprising:
transmitting via RRC signaling to the UE an indication of whether the UE uses the first dataset or the second dataset;
wherein said second dataset consists of:
a set of MCS levels with one or more modulation types no higher than 64QAM;
or
a set of MCSs levels including QPSK, 16QAM, 64QAM and higher order modulation types comprising 256QAM, these MCSs levels being a subset of combinations of these modulation types with code rates.

6. The method of claim 3, wherein said deciding decides whether the UE uses the first dataset or the second dataset according to a category of the UE, and said category relates to at least any one UE feature of:
a communication capability of the UE;
an implementation supports of the UE;
a service level of the UE.

7. The method of claim 6, wherein said first dataset consists of a set of MCS levels with one or more modulation types including QPSK, 16QAM, 64QAM and higher order modulation types comprising 256QAM, and said MCS levels are a subset of combinations of these modulation types with code rates.

8. The method of claims 3 wherein the lengths of the first index and the second index are 5 bits, and the message is DCI format.

9. A method in an UE for receiving MCS, comprising:
receiving from an eNB a message with a first index, wherein the first index is used to select a MCS level from a first dataset, wherein the first dataset comprising any one of:
one or more modulation types higher than 64QAM;
one or more combinations of given modulation types and code rates different from corresponding given code rates;
determining the MCS according to said first index and said first dataset.

10. A method of claim 9, wherein said first dataset comprises a set of MCS levels including QPSK, 16QAM, 64QAM and higher order modulation types comprising 256QAM,
and said MCS levels in said first dataset are a set of combinations of these modulation types with different code rates, wherein the higher modulation types are combined with lower and/or higher code rates.

11. A method of claim 9, further comprising:
deciding whether or not that the UE uses the first dataset, when deciding that the UE uses the first dataset, performing said receiving and determining otherwise, performing:
receiving from an eNB another message with a second index, wherein said second index is used to select a MCS level from a second dataset comprising one or more modulation types no higher than 64QAM;
determining the MCS according to said second index and said second dataset.

12. A method of claim 11, wherein said first dataset consists of:
a set of MCS levels without QPSK, 16QAM or 64QAM; or
a set of MCSs levels including QPSK, 16QAM, 64QAM and higher order modulation types comprising 256QAM, these MCSs levels being a subset of combinations of these modulation types with code rates;
said second dataset consists of:
a set of MCS levels with one or more modulation types no higher than 64QAM;
or
a set of MCSs levels including QPSK, 16QAM, 64QAM and higher order modulation types comprising 256QAM, these MCSs levels being a subset of combinations of these modulation types with code rates;
the lengths of the first index and the second index are 5 bits, and the message and the another message are DCI formats.

13. A method of signaling MCS, comprising steps of:
generating a message with a first index;
transmitting the message with the first index to a UE;
generating another message with a second index;
transmitting said another message with said second index to the UE;
wherein said second index is used for indicating an adjustment to the first index, and said first index and said second index are for determining a MCS level together.

14. A method of claim 13, wherein said transmitting the another message with the second index and said transmitting the message with the first index are respectively in contiguous subframes or in subframes within a certain interval;
and wherein, the MCS level determined by the first index and the second index is from a set of MCS levels with the modulation types including one or more modulation types higher than 64QAM; and
the lengths of the first index and the second index are 5 bits, and the message and the another message are DCI format.

15. A method of receiving MCS, comprising:
receiving a message with a first index;
receiving another message with a second index;
wherein said second index is used for indicating an adjustment to the first index, and said first index and said second index are for determining a MCS level together;
determining the MCS according to the first index and the second index.

16. A method of claim 15, wherein said receiving the another message with the second index and said receiving the message with the first index are respectively in contiguous subframes or in subframes within a certain interval;
and wherein, the MCS level determined by the first index and the second index is from a set of MCS levels with the modulation types including one or more modulation types higher than 64QAM; and
the lengths of the first index and the second index are 5 bits, and the message and the another message are DCI format.
